(19) United States
(12) Patent Application Publication
(10) Pub. No.: US 2004/0218051 A1
(43) Pub. Date: Nov. 4, 2004

(54) Digital camera with function of pen

(76) Inventor: Jeou-En Hsu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/867,500

(22) Filed: May 31, 2001

(30) Foreign Application Priority Data
Apr. 11, 2001 (TW) 090108594

(51) Int. Cl. H04N 5/225

(52) U.S. Cl. 348/207.99

(57) ABSTRACT

A digital camera with a function of a pen and a method for manufacturing the same are disclosed. A digital camera is combined with a pen. The digital camera with a function of a pen is a high technology product and is interest. A memory is embedded therein and the data is transferred to a receiving end for being processed. The casing has a power supply and a photograph button. The digital camera with a function of a pen includes a casing module, a circuit module, a photo capture module and a pen.

### FIELD OF THE INVENTION

The present invention relates to a digital camera with a function of a pen, especially, which is made by a modularized way so as to combine a digital camera and a pen.

### BACKGROUND OF THE INVENTION

Digital cameras are more and more popular since the data captured by the digital camera can be inputted to a computer for displaying or processing to present various effects which can not achieved by the conventional cameras. However, in general, the record of a real scenery includes images and something not presenting by image but must be record by pen. For example, a reporter general records an event by capturing images and writing something thereabout. If the reporter is desired to record an event, it must take a digital camera and an extra pen. This is very inconvenient. This is not encountered by reporters, many people using digital camera has such an experience. Therefore, there is an eager demand for a digital camera which is combined with a pen so that users may use the two functions conveniently.

### SUMMARY OF THE INVENTION

Accordingly, the primary object of the present invention is to provide a digital camera with a function of a pen, wherein the user may record an image real time by a photograph or a text by pen.

Another object of the present invention is to provide a digital camera with a function of a pen, wherein a child may skill the operation of a digital camera so that the parents are unnecessary to buy a high cost product.

A further object of the present invention is to provide a digital camera with a function of a pen which can be carried conveniently and easily.

A yet object of the present invention is to provide a digital camera with a function of a pen, wherein to make a digital camera with a function of a pen to be versatile, a modularized way is used in the present invention. At first, each component is made individually, and then all the components are assembled.

To achieve above objects, the present invention provides a digital camera having functions of a digital camera and a pen, wherein an embedding memory is used to record an image, and then an I/O port is used to transfer the image to a receiving end; the digital camera with a function of a pen comprises the following components. A casing module is formed by a front casing and a rear casing and having a photo capture frame. A window has a transparent plate for aiming the object to be captured. An LCD display screen serves for displaying the residue sheets; an I/O port position; a pen cover being at a lower end of the casing and having tenons at an inner periphery for buckling the pen not to drop out, a key set and a buckling ring. A circuit module has a microprocessor, a memory, a counting circuit, a power supply circuit, and an output port for transferring photograph data in a memory to a receiving end. A photo capture module having a photo lens. By the circuit module and photo capture module, a compact portable digital camera with a function of a pen is formed, it can be hung on the neck; the digital camera is used to record an image; therefore, the user can record data by photographs and writing by a pen.

The various objects and advantages of the present invention will be more readily understood from the following detailed description when read in conjunction with the appended drawing.

### BRIEF DESCRIPTION OF THE DRAWINGS

FIG. 1A is a front view of the digital camera with a function of a pen of the present invention.

FIG. 1B is a rear view of the digital camera with a function of a pen in the present invention.

FIG. 2 is a block diagram of the digital camera with a function of a pen in the present invention.

FIG. 3 is a block diagram showing the structure and manufacturing of the digital camera with a function of a pen in the present invention.

FIG. 4 shows another shape of the digital camera with a function of a pen in the present invention.

FIG. 5 is a schematic view showing the wearing of the digital camera with a function of a pen in the present invention.

### DETAILED DESCRIPTION OF THE PREFERRED EMBODIMENTS

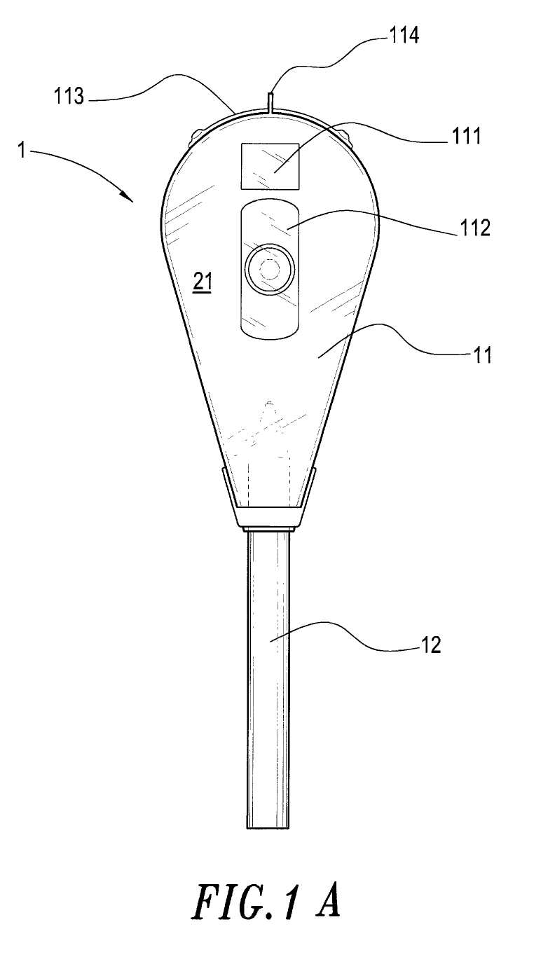

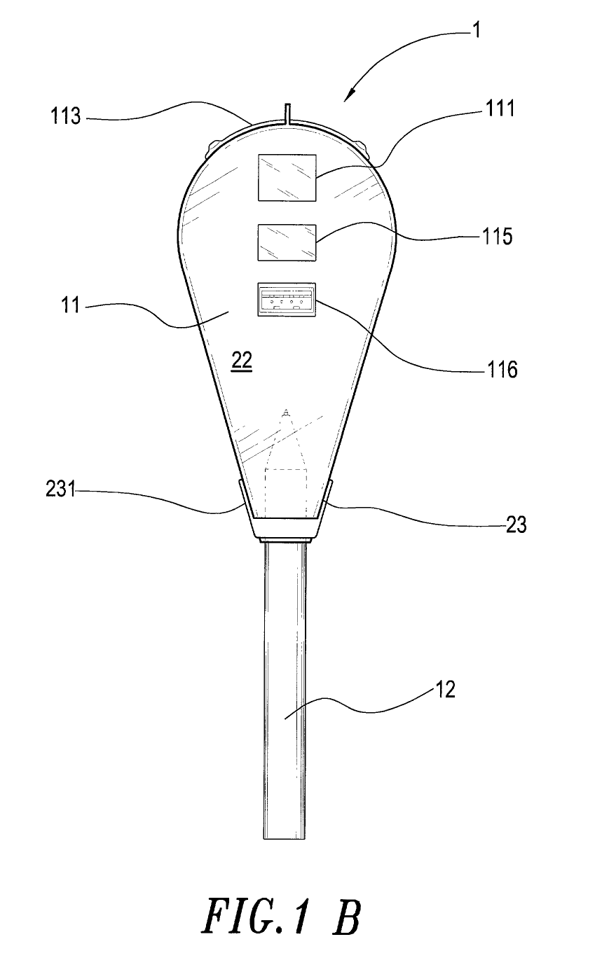

Referring to FIG. 1A, the front view of the digital camera with a function of a pen of the present invention is illustrated. The digital camera with a function of a pen includes a digital camera 11 and a pen 12. The digital camera 11 has a window 111, a photo capture frame 112, a key set 113, etc. The uppermost thereof has a buckling ring 114 for being passed by a rope or a chain. The whole digital camera with a function of a pen 1 is worn on the neck for being carried.

Referring to FIG. 1B, a rear view of the digital camera with a function of a pen is illustrated. It is illustrated that the digital camera with a function of a pen includes a window 111, as the window 111 in FIG. 1A, it has a transparent plate for viewing the image to be captured, a small size LCD display screen 115 for displaying the residue films; an output ports 116 in general being an USB output port.

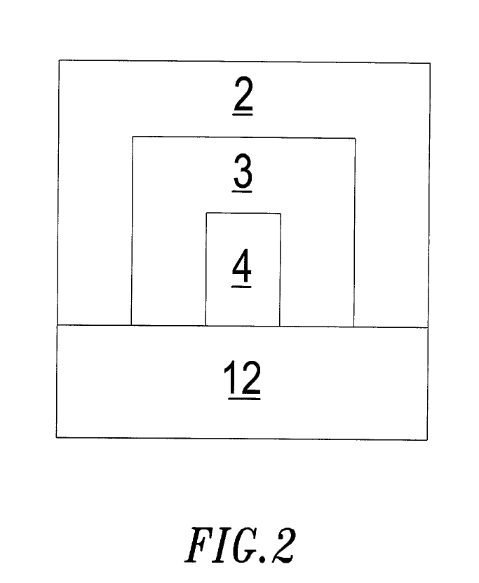

A modularized way is to manufacture the present invention quickly and easily. Each component is manufactured singly and then is assembled so as to finish the digital camera with a function of a pen of the present invention. With reference to FIG. 2, a block diagram is illustrated. The digital camera with a function of a pen 1 is formed by a casing module 2, a circuit module 3, a photo capture module 4, etc. Referring to FIGS. 1A and 2B again, the casing module 2 is formed by a front casing 21 and a rear casing 22 and has a photo capture frame 112. Thereby, as the photo capture module 4 is installed into the casing, then the image is captured through this photo capture frame 112. The window 111 has a transparent plate for viewing the object to be captured. The pen cover 23 is at the lower end of the casing and has tenons at the inner periphery for buckling the pen 12 not to drop out. A buffer plastic pad 231 is used to assist in rubbing with other object. A key set 113 and a bucking ring 114 are included. The circuit module 3 includes a microprocessor, a memory, a counting circuit, a power supply circuit, and an output port. The power supply can be replaced by battery. The photo capture module 4 includes a photo lens. The circuit module 3 and the photo capture module 4 are made at the same substrate and are encased by silicon. Only, the lens, LCD display screen, I/O ports, and control portion for controlling the key set are exposed out.

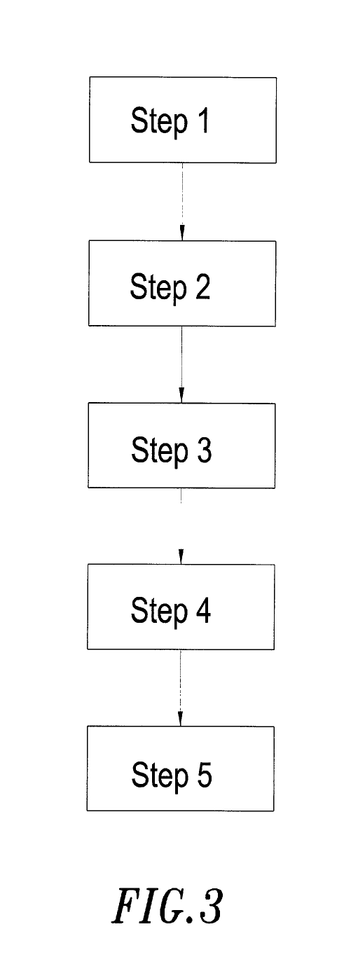

Referring to FIG. 3, the step of manufacturing the digital camera with a function of a pen of the present invention is illustrated, which can be made rapidly, and correctly with a lower cost.

Step 1: Making the circuit module and photo capture module at the same substrate.

Step 2: Fixing the circuit module and photo capture module by silicon so that a circuit substrate matching the form of the casing, lens, LCD display screen, I/O ports, and control portion for controlling the key set.

Step 3: Encasing the circuit substrate closing by silicon, and matching the exposing portions to the respective portions of the casing; for example, the lens is correspondent to the aperture frame of the casing, and the control portion is correspondent to the key set 113.

Step 4: Covering a buffering rubber pad to the pen cover and key set for increasing friction force.

Step 5: Inserting a pen into a pen cover.

The key set of the casing includes a power supply and a photograph button. In photography, the power is firstly actuated. The power supply is only necessary to be pressed once. The LCD display screen is actuated. The user may understand that it is started up. The photograph button is pressed. A photograph is captured as the button is pressed once. Then the data is stored in a memory. The number of sheets will be displayed on the LCD display screen. After the memory space is full, the data is transferred to the receiving end from the I/O ports (in general, a USB port) for further processing. After receiving, the data is removed from the memory so that the user may use it again.

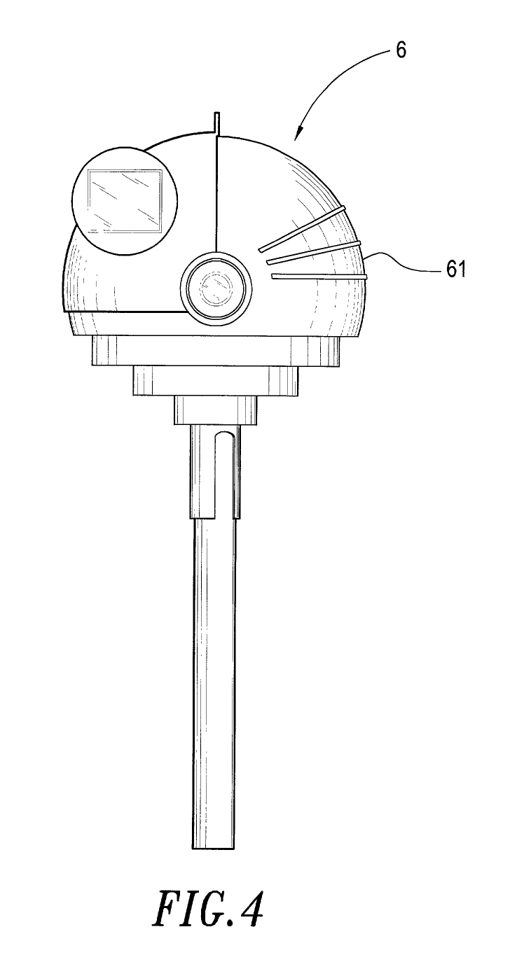

To make the digital camera with a function of a pen to be versatile, a modularized way is used in the present invention, which conforms the requirements of cost and speed. Referring to FIG. 4, another digital camera with a function of a pen 6 of the present invention is illustrated. Part of the digital camera 61 has a round shape. Therefore, as the circuit module and the photo capture module are made at the same circuit substrate. It is noted that the circuit substrate must match to the casing. The silicon is given an enclosing form so that the lens, LCD display screen, and I/O ports, and control portion for controlling the key set are matched to the casing.

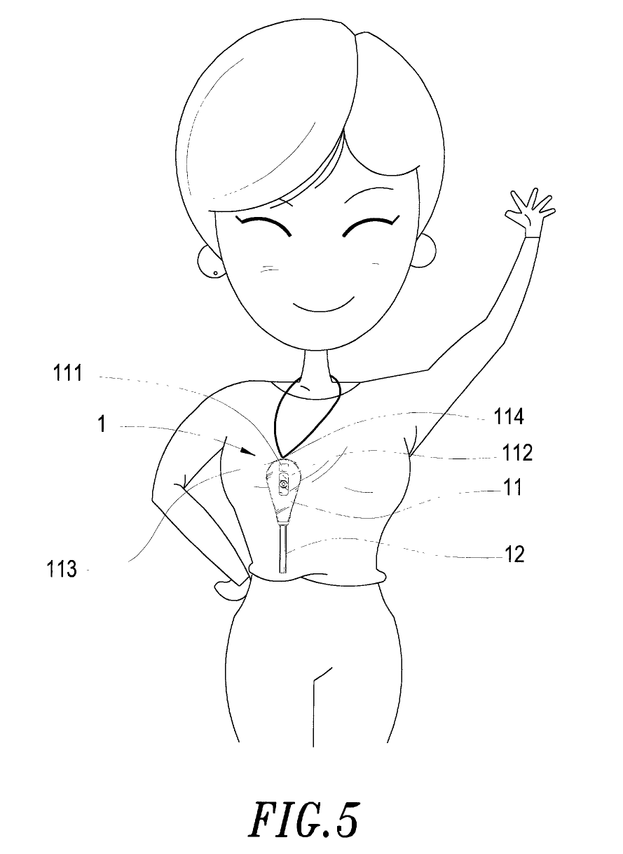

With reference to FIG. 5, the volume of the digital camera with a function of a pen of the present invention is correspondent to a general pen. If it is carried by the user, it has no affect to the action of the user. Furthermore, it has a special outlook and is practical. Therefore, it is novel and inventive.

The digital camera with a function of a pen of the present invention has the following advantages:

1. The present invention can be made to have different structures and appearances to match the requirement of user. Moreover, the present invention is compact and convenient.

2. The event being occurring can be recorded real time.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing a digital camera with a function of a pen comprising the steps of:
making a circuit module and a photo capture module at the same substrate;
fixing the circuit module and photo capture module by silicon so that a circuit substrate matching forms of a casing, a lens, an LCD display screen, I/O ports, and a control portion for controlling the key set;
encasing the circuit substrate closing by silicon using by a front and a rear casing, and matching the exposing portions to the respective portions of the casing; and
inserting a pen into a pen cover.

2. A method for manufacturing a digital camera with a function of a pen comprising the steps of:
making a circuit module and a photo capture module at the same substrate;
fixing the circuit module and photo capture module by silicon so that a circuit substrate matching forms of a casing, a lens, an LCD display screen, I/O ports, and a control portion for controlling the key set;
encasing the circuit substrate closing by silicon, and matching the exposing portions to respective portions of the casing;
covering a buffering rubber pad to a pen cover and a key set for increasing friction force; and
inserting a pen into a pen cover.

3. A method for manufacturing a digital camera with a function of a pen as claimed in claim 1 or 2, wherein to matching the casing, the circuit module and photo capture module are made at the same circuit substrate.

4. A digital camera having functions of a digital camera and a pen, an embedding memory being used to record an image, and then an I/O port being used to transfer the image to a receiving end; the digital camera with a function of a pen comprising:
a casing module formed by a front casing and a rear casing and having a photo capture frame; a window having a transparent plate for viewing the object to be captured; an LCD display screen for displaying the residue sheets; an I/O port position; a pen cover being at a lower end of the casing and having tenons at an inner periphery for buckling a pen not to drop out, a key set and a buckling ring;
a circuit module having a microprocessor, a memory, a counting circuit, a power supply circuit, and an output port for transferring photograph data in a memory to a receiving end; and
a photo capture module having a photo lens;
wherein by the circuit module and photo capture module, a compact portable digital camera with a function of a pen is formed, it can be hung on the neck; the digital camera is used to record an image; therefore, the user can record data by photographs and writing by a pen.

5. The digital camera having functions of a digital camera and a pen as claimed in claim 4, wherein the key set is installed with a buffer pad for enhancing a friction force.

6. The digital camera having functions of a digital camera and a pen as claimed in claim 4, wherein the key set includes a power switch and a photograph button.

7. The digital camera having functions of a digital camera and a pen as claimed in claim 4, wherein the I/O port is a USB port.
